(19) United States
(12) Patent Application Publication
(10) Pub. No.: US 2013/0097223 A1
(43) Pub. Date: Apr. 18, 2013

(54) COMPUTER NETWORK ASSET MANAGEMENT

(71) Applicants: Alexander Mishkevich, Berkeley Heights, NJ (US); Reuben O. Wells, Tonbridge (GB)

(72) Inventors: Alexander Mishkevich, Berkeley Heights, NJ (US); Reuben O. Wells, Tonbridge (GB)

(73) Assignee: MORGAN STANLEY, New York, NY (US)

(21) Appl. No.: 13/274,647

(22) Filed: Oct. 17, 2011

(51) Int. Cl. G06F 15/16

(52) U.S. Cl. 709/203; 709/201

(57) ABSTRACT

An apparatus is described including a central connection manager having a contact rules engine, the contact rules engine being configured to allow contact rule creation and to provide contact rule management such that created contact rules will apply to each of the multiple distributed applications and servers owned by each of the multiple distributed applications. A computerized method of managing contact information for deployed applications and deployed servers in a geographically distributed network is also described. The method involves maintaining an ownership relationship between the deployed applications and the deployed servers such that every server is owned by at least one application, maintaining a centralized repository of contact rules and managing the contact rules such that when a rule parameter of a specific rule changes, the change will be applied to all impacted deployed applications.

### FIELD OF THE INVENTION

This application generally relates to computers and, more particularly, to management of computer assets.

### BACKGROUND

It is not uncommon for companies with multiple offices that are geographically remote from each other, whether within the same city or scattered around the globe, to have at least some computer assets, both hardware and software, networked among those offices. Companies employ information technology (IT) personnel to make sure that those assets function as needed and, when some form of event occur that affects the operation of those assets, to fix the problem or otherwise minimize the impact on operations as quickly as possible.

As network size and the number of assets increase, as well as increase in number of teams responsible for maintaining such assets, it becomes less and less practical for companies to have all the personnel necessary at each location who can maintain or repair the assets at each of those locations.

Moreover, in many cases, larger companies may actually have multiple heterogeneous architectures that are, from an IT perspective, physically interconnected to each other and can impact each other but, from a user perspective, they are discrete and separate, if visible at all. Still further, software assets, may also be distributed across multiple servers in different geographical locations and there may not be a 1:1 correspondence between server(s) and placement of distributed software components such that, if a failure occurs that affects one of those software assets, it may be difficult to quickly ascertain where the failure physically occurred so that the proper IT personnel to address the problem can be notified or dispatched.

Although some networks may operate without oversight unless and until a problem is identified due to its effect, larger networks in larger organizations cannot function that way, downtime is simply too critical and costly. As a result, those organizations will typically have some form of monitoring system in place to identify when a problem occurs and may also have a notification system to notify IT personnel when it does. However, to do so effectively when a problem is identified, the right IT personnel with responsibility for handling the particular problem must be notified. This is typically done by having, at each location or for each server, a listing of one or more persons who should be contacted in case some particular event involving the computer assets occurs. In addition, there may also be some form of secondary notification if, for example, the primary contact does not or cannot respond.

This would be relatively easy, even for a larger network, if changes in the network assets and/or responsible IT personnel were infrequent. However, the reality of larger organizations is that hardware and software demand and needs change fairly often, as do IT and other personnel. New or upgraded hardware or applications may be deployed at a particular location without the knowledge of others at a different location and/or existing responsible people may leave or assume new roles, or new people may be hired or move within the organization and thereby assume the roles and responsibilities previously held by others.

Under ideal circumstances whenever this happens, contact information would be updated everywhere necessary. In reality, such comprehensive updates rarely happen, particularly where distributed assets are involved due to the difficulty in ascertaining all assets impacted by a particular change. This is because there may be different contacts for different physical locations or particular hardware assets and, in the case of software assets, they may need to have their own contacts, which may be different depending upon both the software itself and where the physical assets on which the software is running resides.

As a result, it is not uncommon for at least some notification information to easily become out of date, i.e. “stale.” This can be highly problematic and costly if a critical event occurs and the only contact information available is stale.

Accordingly, there is a need for a better way to manage IT assets in networks made up of heterogeneous architectures and/or distributed software in geographically dispersed locations.

### SUMMARY

One aspect involves an apparatus including multiple servers, at least one of the multiple servers being geographically remote from at least another of the multiple servers and an asset inventory comprising multiple distributed applications. Each of the multiple servers is owned by at least one of the multiple distributed applications. Each of the multiple servers has associated server contact information and application contact information, the contact information identifying whom to contact when an alert event occurs. The apparatus further involves at least one network interconnecting some of the multiple servers to others of the multiple servers and a central connection manager comprising a contact rules engine. The contact rules engine is configured to allow contact rule creation and to provide contact rule management such that created contact rules will apply to each of the multiple distributed applications and servers owned by each of the multiple distributed applications and when a change is made to a contact rule that affects one or more of server contact information and application contact information for one of the multiple distributed applications the change will be implemented throughout the at least one network for the one of the multiple distributed applications and all servers owned by the one of the multiple distributed applications.

Another aspect involves computerized method of managing contact information for deployed applications and deployed servers in a geographically distributed network. The method involves maintaining an ownership relationship between the deployed applications and the deployed servers such that every server is owned by at least one application, maintaining, within a connection management computer system, a centralized repository of contact rules specifying for each of the deployed applications and deployed servers, each of the contact rules comprising rule parameters and contact parameters applicable to at least one the deployed applications or the deployed servers; and managing the contact rules such that a) when a rule parameter of a specific rule changes, the change will be applied to all impacted deployed applications and all applicable deployed servers owned by the impacted deployed applications to which the specific rule applies, and b) when a new rule is added and validated, its parameters will become effective for every application and server to which the rule applies. One example fundamental principle achieved is shifting the burden from micro-management of contact/notification information on device level to the level of the system and/or application which owns one or multiple of such devices, by means of defining generic and well-covering contact/notifications rules for application. This approach results in a reduction in the effort required to sustain operations, as well as provides better gap-less coverage for new devices.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified fashion, a typical configuration for managing IT assets according to the prior art;

FIG. 2 illustrates, in simplified fashion, an overview of a new configuration for managing IT assets;

FIG. 3 is a more detailed conceptual illustration of the contacts manager 214 of FIG. 2;

FIG. 4 illustrates an example entity relationship diagram of a data model suitable for use in implementing the CM server described herein;

FIG. 5, illustrates, in simplified form, a slight variant configuration of the configuration illustrated in FIG. 3;

FIG. 6A illustrates, in simplified form, an example of a template for a rule for a database;

FIG. 6B illustrates the template of FIG. 6A following creation of a rule by populating fields within the template;

FIG. 7 is an illustrative example of a portion of a sample screen 700 of a graphical interface as described herein;

FIG. 8 is a representative, illustrative example of an Audit History window of the graphical interface;

FIG. 9 illustrates, in representative example form, an Edit interface screen for the editable mode;

FIG. 10 illustrates an example “Rules Preview” interface screen;

FIG. 11 illustrates an example Alert;

FIG. 12, illustrates an example edit interface screen; and

FIGS. 13 and 14 are an enlarged portion of the screen of FIG. 12 showing example pull down menus that limit field contents to a predefined list.

### DETAILED DESCRIPTION

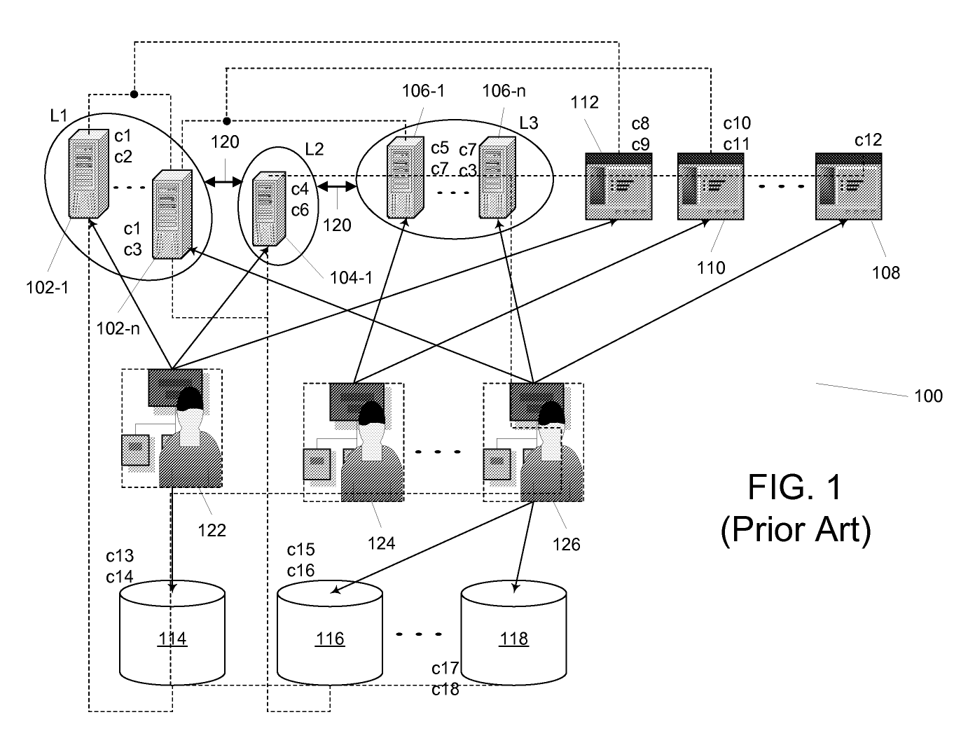

FIG. 1 illustrates, in simplified fashion, a typical configuration for managing IT assets according to the prior art.

As shown, the configuration 100 encompasses multiple physical computers which may number from a few to several hundred or more 102-1 thru 102-n, 104-1, 106-1 thru 106-n (only some of which are shown) that are physically located at least three locations L1, L2 and L3, with some or all of them being connected to each other at their respective locations via one or more networks (not shown). Depending upon the particular actual configuration, different computers can be homogeneous or can be heterogeneous in the sense that they may have entirely different hardware components, capabilities and/or operating systems, and some or all may be configured for use as distributed systems.

Examples of distributed systems and their uses include: telecommunication networks including telephone networks and cellular networks, as well as computer networks such as the Internet, wireless sensor networks, world wide web and peer-to-peer networks, multi-player online gaming and virtual reality communities, distributed databases and distributed database management systems, network file systems, investment and banking systems, airline reservation systems, and special purpose arrangements such as industrial control systems and high-end computer graphics rendering. Depending upon the particular configuration, the distributed system can include permutations and combinations of one or more different architectures such as simple application servers, client-server (two-tier) architectures, three-tier architectures, n-tier architectures, peer-to-peer architectures, workstations, mainframe computers, minicomputers, and personal computers to name a few.

In addition, the configuration 100 can include software individually deployed on specific hardware, distributed software, as well as distributed and/or non-distributed databases. For example, as shown in FIG. 1, one software package 108 runs on a single computer 104-1 at location L2, another distributed software package 110 is distributed over two computers 102-n and 106-1 located at locations L1 and L2. Yet another distributed software package is distributed over multiple computers 102-1, 102-n only at location L1.

Still further, the system includes multiple databases. For example, one database 114 runs entirely on one computer 102-1 at location L1, whereas another database 116 is distributed over two computers, 102-n, 104 at two different locations and yet a different database 118 runs on a different computer 106-n at location L3. In addition, in similar fashion, the assets could include other types of hardware assets such as storage arrays, backup devices, etc.

In addition to being networked together, the computers 102-1, 102-n at location L1, the computer 104-1 at location L2 and the computers 106-1, 106-n at location L3 are all interconnected via a network 120 which may be any one or more of the types of known networks used to interconnect computers at multiple locations.

As can be seen, each computer 102-1, 102-n, 104, 106-1, 106-n has a primary and secondary contact associated with it c1, c2, c3, c4, c5, c6, c7 who are to be contacted in case of an event that potentially affects that hardware device. Similarly, the software packages 108, 110, 112 have associated contacts c8, c9, c10, c11, c12 for software related issues, and the databases 114, 116, 118 have their own contacts c13, c14, c15, c16, c17, c18 for database related issues.

According to the typical approach, different people 122, 124, 126 may be responsible for management of the contacts for the computers, software and databases. For example, as shown, one person 122 is responsible for maintaining the contact information for two computers 102-1, 104-1 as well as a software package 112 and a database 114. Another person 124 is responsible for maintaining the contact information for one of the computers 106-1 and one of the distributed software packages 110. A third person 126 is responsible for maintaining the contact information for another two computers 102-n, 106-n as well as one software package 108 and two databases 116, 118.

As should be appreciated, if, for example, one of those persons 126 changes positions without passing on to a successor an identification of the contact information they are responsible for maintaining, or one of the computers 102-n they are responsible for is replaced by a pair of computers by an IT person at location L1 due to the needs of one of the distributed software packages 110, 112, or if a contact person “c3” leaves or changes roles such that they should not be a contact any longer without that change being conveyed to the proper maintaining person 126, the contact information can easily become stale with potentially costly consequences.

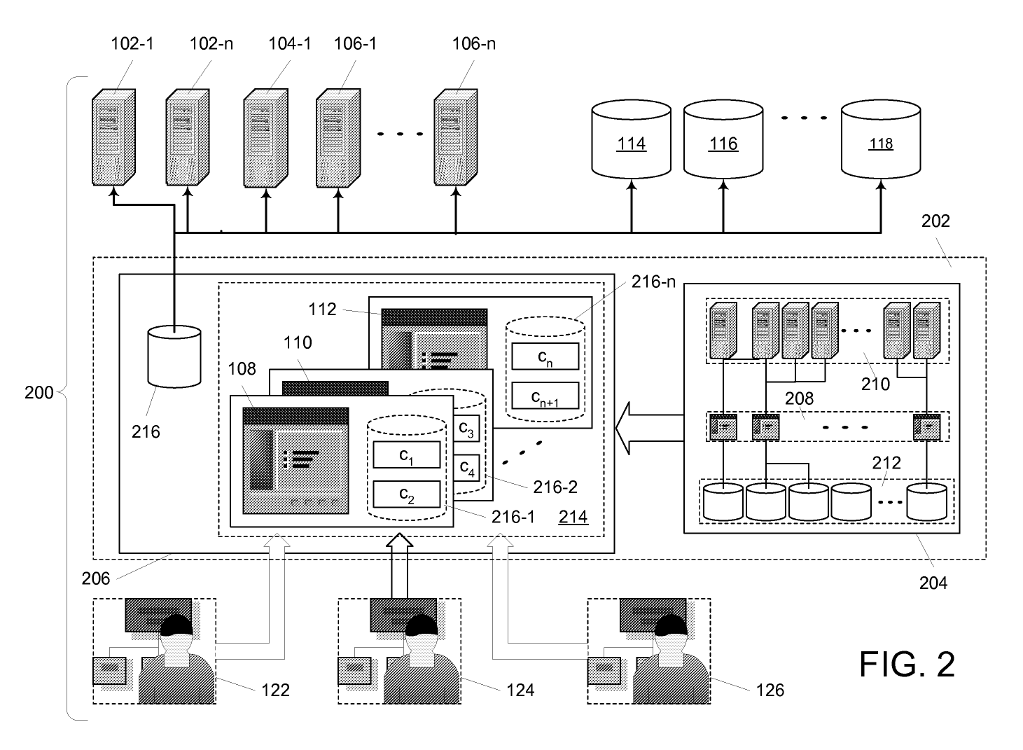

In order to address these problems, as shown in simplified fashion in FIG. 2, a new configuration 200 for management of IT network assets, such as those described in connection with FIG. 1, has been devised.

According to this configuration 200, an asset inventory management system 202 is interposed between the person(s) 122, 124, 126 responsible for maintaining updated contact information and the hardware assets 102-1 thru 102-n, 104-1, 106-1 thru 106-n themselves.

The asset inventory management system 202 is made up of two parts, an asset inventory manager 204, which stores definitions of applications and owned/used resources, and a resource management engine 206 [NOTE: This is what I am calling OCM and ESP].

The asset inventory manager 204, as well as all of the other computers referenced herein are made up of conventional computer hardware (i.e. containing one or more processors, random access memory, read only memory, non-volatile storage, input/output and display device(s)) that runs software to implement conventional features and/or the features described herein. Note that, as used in the description that follows, the term “application” is intended to mean application software as it is conventionally understood as well as other types of software such as database software, operating system software, etc.

The asset inventory manager 204 maintains inventory record of all assets (applications, hardware and databases) that are deployed, can be deployed or that have been removed from service but are still physically owned and additionally provides a federated mechanism that enables one to see all types of resources owned by system and/or application. The asset inventory manager 204 records also associate application instances 208 with all hardware assets 210 and databases 212 to which each application relates. This is referred to herein as “ownership” by an application. Note, this means each hardware asset and database must be owned by at least one application, and a new hardware asset cannot be deployed unless and until a record for at least one application with which it will be associated is added into the asset inventory manager 204. In general, only one instance of an application is recorded in the asset inventory manager 204. However, if the application itself is an instance of some re-usable component or framework, then each instance might then be recorded uniquely within the asset inventory manager 204.

The resource management engine 206 is itself conceptually made up of two parts, a contacts manager 214 and a configuration management database 216. The resource management engine 206 maintains relationships between assets and owning applications.

The configuration management database 216 is where the ownership of all hardware assets by applications is specified and contact information is centrally maintained for each of the assets, irrespective of location. Hardware assets cannot be entered into the configuration management database 216 unless and until they are present in the asset inventory manager 204. In other words, at least each hardware asset will always be owned by at least one application. Thus, non-deployed available hardware assets and hardware assets that have been removed from service (collectively the “inventory pool”) will at least be owned, if by nothing else, by an operating system application. In addition, the configuration management database 216 is, depending upon the particular implementation, where contact information for the assets are maintained or, to the extent contact information is maintained at any specific location(s) or with some specific asset(s), used to propagate such contact information to those locations or assets. Moreover, irrespective of the location or particular assets involved, the configuration management database 216 is the central, sole source of that information as will be described in greater detail below.

The contacts manager 214 is used to associate contacts with applications. In addition, advantageously, the contacts manager 214 operates in a “rule-based” fashion. Due to the ownership approach described above, where applications own resources like hardware and databases, rules are defined on a “per application” basis for all resources the application owns.

As a result, micro-management of individual contacts is unnecessary as is management of contacts at the resource level. Moreover, as a result, persons who can specify or modify rules can be limited. For example, certain people may be allowed to change who gets notified, in certain cases, but can be blocked from changing who gets notified when a change is made or who must give approval before a new rule can be implemented. In addition, rule parameters can be defined, so that the universe of available permutations and combinations of the parameter options can be limited or controlled. Similarly, the system can be set up so that a rule must be “verified” before it can become effective. For example, contact parameters for a rule can be limited to only e-mail groups within the organization as opposed to an e-mail address of a specific individual or the same person can not be specified as a contact for two or more geographically remote locations. In this manner, conflicts can easily be resolved and corresponding changes can be enforced. For example, if person X was the contact person for certain resources in the New York metropolitan area, but transfers to Europe, where they assume new responsibilities as a contact person for certain resources there, when the rule(s) applicable to Europe are modified to reflect person X's new responsibilities or role, validation of that rule results in an error because of a conflict with the rule reflecting person X's prior position. Thus, the rule verification process can force a change that reflects the proper contact information for both locations. In addition, through such a rule change process, the change can automatically be propagated for all impacted assets.

Still further, rules can be “cloned” so that the same rule can be applied slightly differently without risking adversely affecting other rule contents. For example, a rule can be defined to apply to all locations in the western United States. Later, the same rule can be implemented for all locations in Canada merely by cloning the rule and changing, for example in the cloned rule, a “region” field from “US-West” to “Canada.”

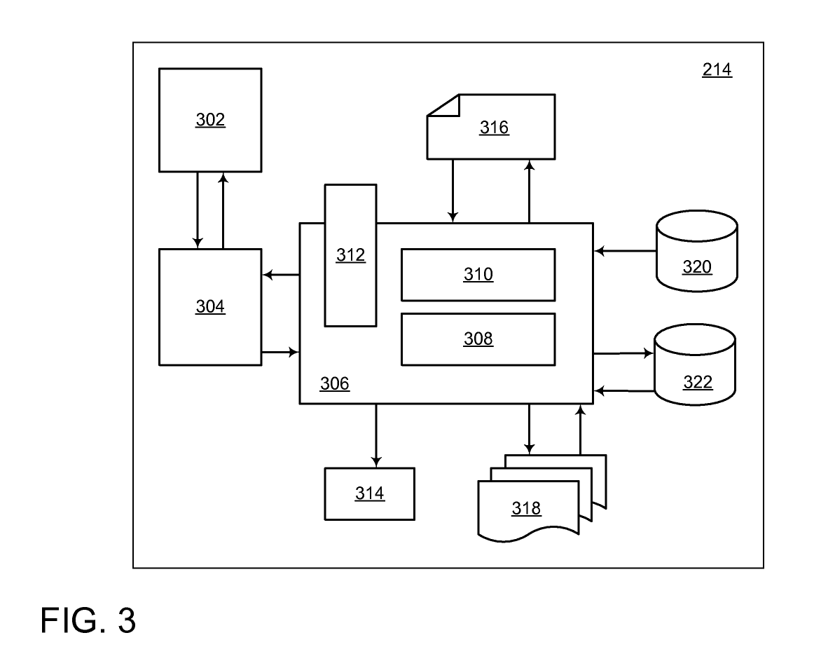

FIG. 3 is a more detailed conceptual view of the contacts manager 214 of FIG. 2.

As shown, the contacts manager 214 includes a user interface 302 through which users can access the contacts manager 214. The user interface (UI) 302 is of any type that will allow a user to accomplish tasks described herein. Since the management system described herein is intended to be a single point for management of the IT assets irrespective of location, access to the management system will typically be via the internet. Accordingly, in most cases, the user interface 302 will be a web page which the user will access using a web browser. The user interface 302 runs on a computer 304 that is configured to present the user interface 302 in the appropriate manner, accept user input and pass appropriate portions of that user input to the contact manager components in an appropriate form for them to process. In the case of a web-based implementation, the computer 304 will typically be a web server. The actual processing performed by the contacts manager 214 is typically handled by another computer, configured as a server, called a CM server 306. The CM server 306 is the “brains” of the contacts manager 214 and is made up of three conceptual components, a Rule Creation/Maintenance Module 308, a Rule Execution Module 310 and an Entitlement Module 312.

The CM server 306 is also implemented to operate in conjunction with programming implementing the Lightweight Directory Access Protocol (LDAP) protocol 314, which is an Internet Engineering Task Force (IETF) specified standard that provides the capabilities for reading and editing organized records over an IP network.

The contacts manager 214 also includes files 316 that contain contact records, files 318 which store configuration information and attribute values, as well as one or more databases 320, 322 for storing the contact management information on, or with, which rules operate.

In general the contacts manager 214 includes two major services which serve the UI requests from the browser, one service class receives all the query requests and then, in turn, it communicates with the CM server 306 via a call/return approach and returns data back to the UI. The other service receives all the create/update/delete requests from UI. In turn, this service calls the CM server to create or update contact rules.

The CM server 306 includes four major services: “SystemContacts”—which is responsible for read and write operations of contact rules, “Configurations”—which reads Resource Type and other configuration details, “SystemEntitlements”—which is used to determine entitlements using data from one of the databases 320, 322 and LDAP 314, and “Contacts”—which applies the rules on the resources read from one of the databases 320, 322 and may also be used, in some cases, for preview and validation.

Optionally, the CM server 306 can further be configured to periodically run various batch jobs which can, for example, generate contacts (for example, from personnel-related data from other sources) and/or output updated data for provisioning to local applications or servers.

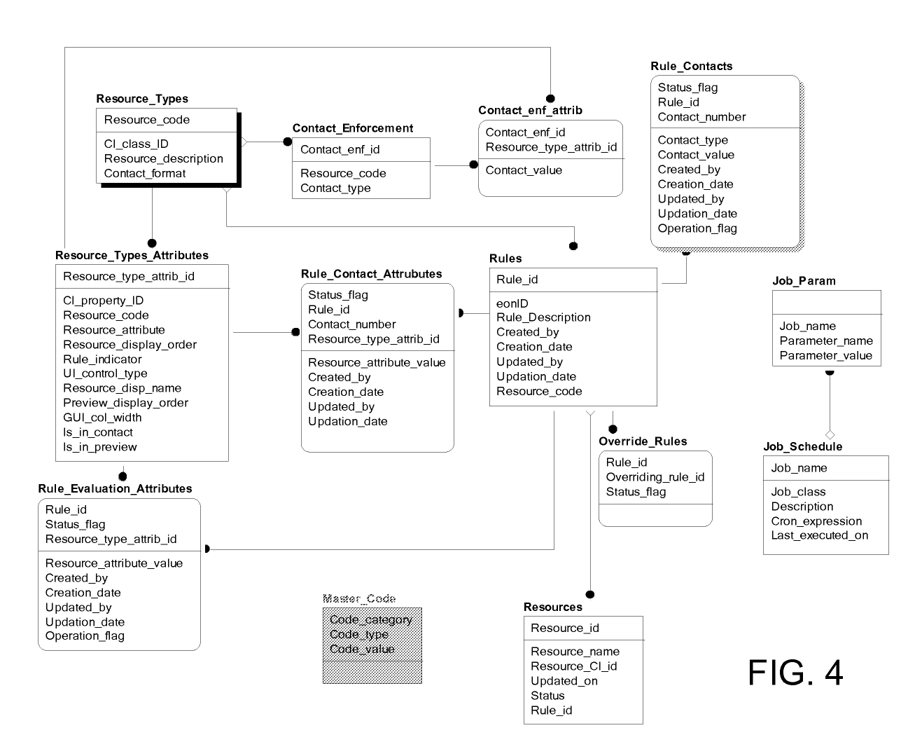

FIG. 4 illustrates an example entity relationship diagram of a data model suitable for use in implementing the CM server 306. The illustrated entities of FIG. 4 and their contents are as follows:

The Resource Type entity would contain information about the resource types. This is shown in Table 1.

TABLE 1

| | Keys/ | Example | |
|---|---|---|---|
| Attributes | Constraints | Values | Comments |
| Resource_code | Primary Key | DB, Server | |
| Resource_ | | | Description about the |
| description | | | resources. |
| CI_Class_ID | | | Referring to database |
| | | | for Class of the |
| | | | Resource_type. |
| Contact_format | | XML/TEXT | |

The Resource Type Attributes entity would contain information about the attributes required for the resource types. This is shown in Table 2.

TABLE 2

| | Keys/ | | |
|---|---|---|---|
| Attributes | Constraints | Example Values | Comments |
| Resource_type_attribute_id | Primary | Auto | |
| | Key | generated | |
| CI_property_ID | | | Referring to database |
| | | | to fetch description for |
| | | | resources |
| Resource_code | Foreign Key | DB, Server | Referring to |
| | | | Resource_Types |
| Resource_attribute | | Environment, Region, | Description for |
| | | Timezone | resource attributes. |
| Resource_display_order | | 1, 2, . . . | Order for displaying |
| | | | the columns |
| Rule_indicator | | Y, N | Describes whether it's |
| | | | a rule parameter or |
| | | | contact attribute |
| UI_control_type | | Combobox/ | To decide which |
| | | textbox | control to use in UI |
| Resource_disp_name | | DB Platform/Region | Resource display |
| | | | name |
| Preview_display_order | | 1, 2, 3, . . . | Order for displaying |
| | | | the columns |
| GUI_col_width | 20, 30, . . . | | |
| Is_in_contact | | Y/N | To decide the attribute |
| | | | goes in main screen |
| Is_in_preview | | Y/N | To decide the attribute |
| | | | goes for preview |
| | | | screen |

The Rules entity would contain the rules. This is shown in Table 3.

TABLE 3

| | Keys/ | | |
|---|---|---|---|
| Attributes | Constraints | Example Values | Comments |
| Rule_id | Primary Key | Auto generated | |
| eonID | | | Related to a particular |
| | | | application. |
| Resource_code | Foreign Key | DB, SRVR | |
| Rule_description | | | Description DB/Server |
| Created_by | | ID | Creator's login id |
| Creation_date | | Date time for | Creation date and time |
| | | creation | |
| Updated_by | | ID | Updator's login id |
| Updation_date | | Date time for | Updating date and time |
| | | updating | |

The Rule Evaluation Attributes entity would contain the detail information about the Rules. This is shown in Table 4.

TABLE 4

| | Keys/ | Example | |
|---|---|---|---|
| Attributes | Constraints | Values | Comments |
| Rule_id | Primary Key + | | Referring to Rules |
| | Foreign Key | | |
| Status_flag | Primary Key | C, D | Maintaining status as |
| | | | confirmed or draft for rule |
| | | | parameters. |
| Resource_type_attribute_id | Primary Key + | | Referring to |
| | Foreign Key | | Resource_Type_Attributes |
| Resource_attribute_value | | Outage, 24x7, | Related to |
| | | PROD, NY | Resource_Type_Attributes |
| | | | value for Resource_attribute |
| | | | or for Connection Property |
| Operation_flag | | A/U/D/N | Maintains id that a row has |
| | | | been added/updated/deleted |
| Created_by | | ID | Creator's login id |
| Creation_date | | Date time for | Creation date and time |
| | | creation | |
| Updated_by | | ID | Updator's login id |
| Updation_date | | Date time for | Updating date and time |
| | | updation | |

The Override Rules entity would have the overriding details about any particular rule. This is shown in Table 5.

TABLE 5

| | Keys/ | Example | |
|---|---|---|---|
| Attributes | Constraints | Values | Comments |
| Rule_id | Primary Key | | Rule_id which is being overridden |
| Overriding_rule_id | Primary Key | | Rule_id which is overriding that rule_id |
| Status_flag | Primary Key | C, D | Maintaining status as confirmed or draft for |
| | | | override rules. |

The Rule Contacts entity would have details about Contacts and their types. This is shown in Table 6.

TABLE 6

| | Keys/ | | |
|---|---|---|---|
| Attributes | Constraints | Example Values | Comments |
| Rule_id | Primary Key | | Referring to Rules |
| Contact_number | Primary Key | Auto Generated | The auto generation is reset |
| | | | to 1 for each rule |
| Status_flag | Primary Key | C, D | Status Confirmed or Draft |
| | | | for Rule Contacts |
| Contact_type | | MailGroup, systemRole, | |
| | | systemAttribute | |
| Contact_value | | admin, IT Owner | |
| Operation_flag | | A/U/D/N | Maintains, if a row has been |
| | | | added/updated/deleted |
| Created_by | | ID | Creator's login id |
| Creation_date | | Date time for creation | Creation date and time |
| Updated_by | | ID | Updator's login id |
| Updation_date | | Date time for updation | Updating date and time |

The Rule Contact Attributes entity would have details about Contact attributes. This is shown in Table 7.

TABLE 7

| | Keys/ | Example | |
|---|---|---|---|
| Attributes | Constraints | Values | Comments |
| Rule_id | Primary Key | | Referring to Rules |
| Contact_number | Primary Key | Auto | Auto generation is reset to 1 |
| | | Generated | for each rule |
| Status_flag | Primary Key | C, D | Status Confirmed or Draft for |
| | | | Rule Contact_Attributes |
| Resource_type_attribute_id | Primary Key + | | Referring to |
| | Foreign Key | | Resource_Type_Attributes |
| Resource_attribute_value | | Outage, 24x7, | Related to |
| | | PROD, NY | Resource_Type_Attributes |
| | | | value for Resource_attribute or |
| | | | for Contact Information |
| | | | Property |
| Created_by | | ID | Creator's login id |
| Creation_date | | Date time for | Creation date and time |
| | | creation | |
| Updated_by | | ID | Updator's login id |
| Updation_date | | Date time for | Updation date and time |
| | | updation | |

The Contact Enforcement entity would be used to restrict the values of contact attributes for particular values of contact type. This is shown in Table 8.

TABLE 8

| | Keys/ | | |
|---|---|---|---|
| Attributes | Constraints | Example Values | Comments |
| Contact_enf_id | Primary Key | Auto Generated | |
| Resource_code | | DB, Server | Referring to |
| | | | Resource_Types |
| Contact_type | | MailGroup, Role | |

The Contact Enforcement Attribute entity would contain the contact attribute values that are to be taken for a given contact type. This is shown in Table 9.

TABLE 9

| | Keys/ | | |
|---|---|---|---|
| | Con- | Example | |
| Attributes | straints | Values | Comments |
| Contact_enf_id | Primary | | Referring to |
| | Key | | Contact_Enforcement |
| Resource_type_attribute_id | Foreign | | Referring to |
| | Key | | Resource_Type_Attributes |
| Contact_value | | Admin, | |
| | | IT | |
| | | Owner | |

The Job Schedules entity would contain the description of the job execution to periodically generate a contact file. It would contain time and/or frequency of job execution. This is shown in Table 10.

TABLE 10

| | Keys/ | | |
|---|---|---|---|
| Attributes | Constraints | Example Values | Comments |
| JOB_NAME | Primary | Generate Hardware | |
| | Key | Contacts/Generate | |
| | | Database Contacts | |
| JOB_CLASS | | | |
| DESCRIPTION | | This Job generates the | |
| | | contacts based on the | |
| | | rules set | |
| CRON_EXPRESSION | | | |
| LAST_EXECUTED_ON | | Jan. 26, 2010 | |
| | | 7:59:18.857000 PM | |

The Job Parameters entity would contain the parameters used to execute the Jobs like File path, resource type etc. This is shown in Table 11.

TABLE 11

| | Keys/ | | |
|---|---|---|---|
| Attributes | Constraints | Example Values | Comments |
| JOB_NAME | Foreign Key | Generate Hardware Contacts/ | Referring to |
| | | Generate Database Contacts | Job_Schedules |
| PARAMETER_NAME | | resourceType/contactsFormat | |
| PARAMETER_VALUE | | SRVR/TEXT | |

The Resources entity contains details of the Resources. It contains resources generated by validation job. These are resources from one of the databases 320, 322 which satisfies the entered rules. This is shown in Table 12.

TABLE 12

| | Keys/ | Example | |
|---|---|---|---|
| Attributes | Constraints | Values | Comments |
| RESOURCE_ID | Primary Key | Auto generated | |
| RESOURCE_NAME | | | |
| RULE_ID | | | |
| RESOURCE_CI_ID | | | |
| UPDATED_ON | | | |
| STATUS | | INSERT/DELETE | |
| EONID | | | Identifies a |
| | | | particular |
| | | | application |

The Master Code entity would have all the codes for the resource and contact attributes. In this example, it is for reference only. In use, actual values would be taken from configuration files. This is shown in Table 13.

TABLE 13

| | Keys/ | Example | |
|---|---|---|---|
| Attributes | Constraints | Values | Comments |
| Code_category | Primary Key | Resource_attribute, | |
| | | Contact_attribute | |
| Code_type | Primary Key | REG, ENV | Region, Environment |
| Code_value | Primary Key | NY, LA, PROD, QA | Location (NY, LA), |
| | | | department |
| | | | (production, QA) |

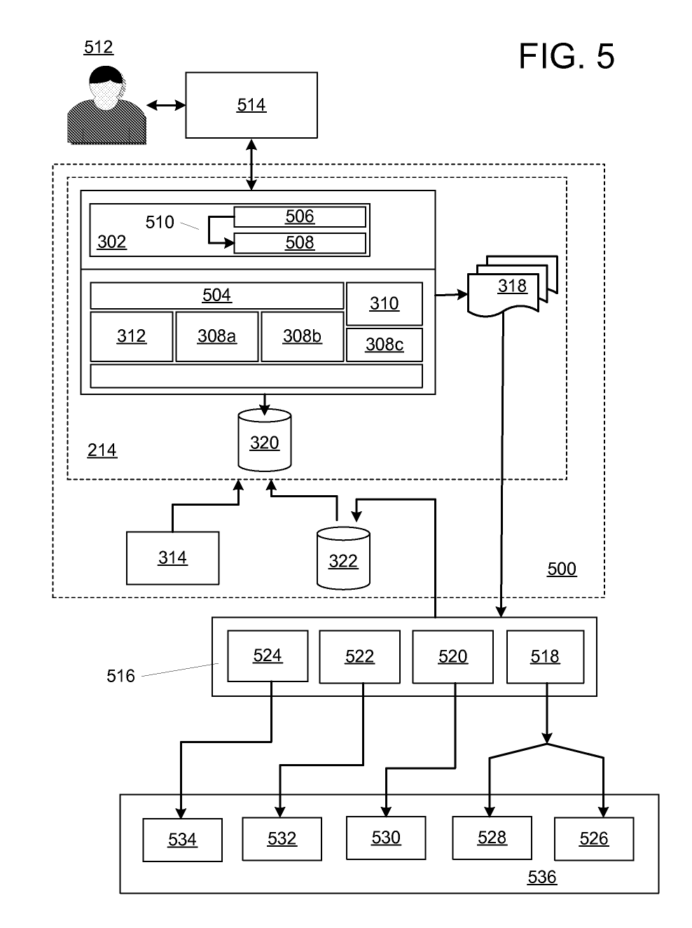

FIG. 5, illustrates, in simplified form, a slight variant configuration 500 of the configuration illustrated in FIG. 3. In the interest of brevity, the description of aspects common to those figures will not be repeated but should be understood to apply.

In general, the configuration of FIG. 5 differs from that of FIG. 3 in the following respects. First, with this configuration, the Rule Creation/Maintenance Module 308 of FIG. 3 is made up of three service modules, a rule creation service module 308a, a rule preview service module 308b, and a rule validator service module 308c. The rule creation service module 308a handles all of the services relating to creation of rules for the contact management. The rule preview service module 308b handles those aspects relating to rules that have been created but not yet validated and shows the effect the rule would have if implemented, thereby allowing the rule creator or modifier an opportunity to “debug” the rule effect as of that point relative to actual operations without actually affecting any real-world operations. The rule validator service module 308c handles validation of a rule once a “commit” operation is initiated, with a commit operation being the initiation of the process of checking the rule's validity having the rule take effect for assets affected by that rule.

In addition, with this configuration, one of the databases 320 of FIG. 3 is part of the contacts manager 214. This database 320 is a contacts database that contains contact and role information used by the rules. Another database 322 is not conceptually part of the contacts manager 214, but rather is a database that contains asset related information for all resources, for example, type of asset, operating system, location, etc. In some cases, this database 322 can also be used to contain the most current contact information applicable to provisioned assets.

Similarly, the LDAP 314 is not part of the contacts manager 214 because the same LDAP 314 implementation is not limited to supporting the contacts manager 214.

In addition, in this configuration, the CM server 306 includes a data access layer, on top of which the Entitlement Module 312, rule creation service module 308a, a rule preview service module 308b and a rule validator service module 308c run. A further service layer 504 runs on top of the Entitlement Module 312, rule creation service module 308a, and rule preview service module 308b and acts as the system level the interface to the user interface 302.

For completeness, as shown, the user interface 302 is a web interface, so interactions with the outside world are handled by UI controls 506 using, for example, the extended javascript library (EXTJS) and Ajax which interface with Java web services 508 via the JavaScript Object Notation (JSON) 510 data interchange format. This allows a user 512 to remotely access the system from a remote location using a conventional browser 514.

The configuration 500 of FIG. 5 would be implemented to interact with the provisioning systems 516 of the particular organization, which could include provisioning for the organizations IT assets such as computer hardware 518 like servers, databases 520, storage arrays (NAS) 522 and/or applications 524, and thereby establish a single point for contact management for all such assets so that all contact information reflects the most up to date information in the system 500. Moreover, if an event occurs with a provisioned asset that requires notification of one or more contacts, that up to date information will be used to notify the appropriate personnel 526, 528, 530, 532, 534, within the support organization 536.

With the above in mind the function, operation and use of IT asset contact management configurations as described herein will now be discussed.

In general, a rule consists of Rule Parameters and Contact Details. Rule Parameters are the resource attribute values used to specify the IT assets (i.e. resources) for which the contacts will be defined. Contact Details include the actual contact information and other contact attributes.

The rules are resolved to the actual resources and, once effective, the contacts are updated directly or in the provisioning system for the particular resource(s). To the extent that there may be a parent-child relationship involving a resource, typically, a contact rule defined for the parent will applies to all applicable child resources as well.

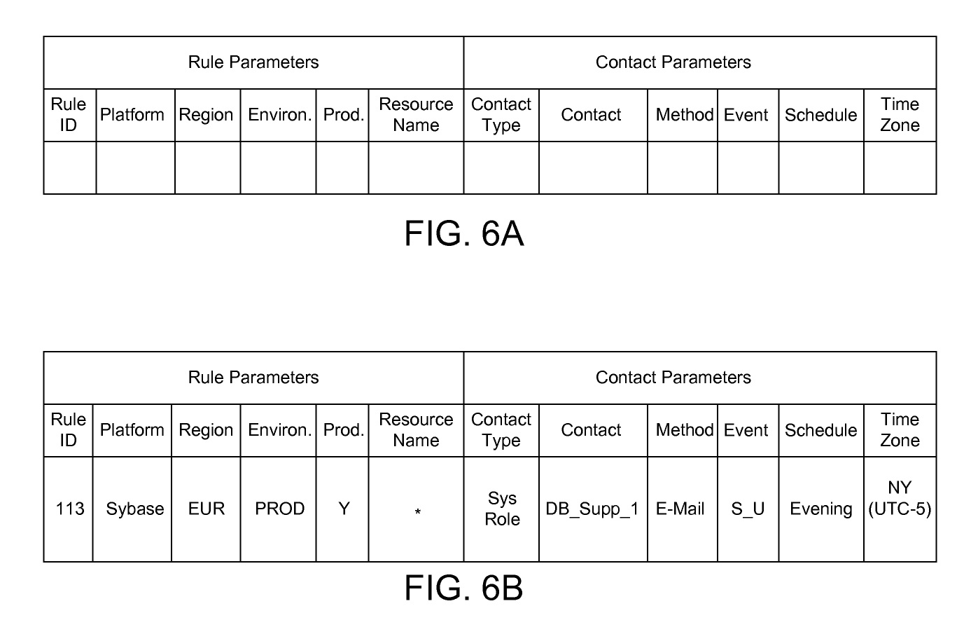

FIG. 6A illustrates, in simplified form, an example of a template for a rule for a database. FIG. 6B illustrates the template of FIG. 6A following creation of a rule by populating fields within the template. As shown, the created rule of FIG. 6B defines that for All PROD Sybase databases in Europe region the person in IT Support role of that system is the contact, and has the noted contact parameters. Note that, in general, more than one contact can be part of a single rule.

Consistent with most IT management systems, a contact management systems constructed for operation as described herein can be configured to allow for multiple levels of access, from no access at all, to “read only” access, to “approval only” access, to “full rights” access. Moreover, access can be limited on a resource basis, such that a particular level of rights can be limited to those persons responsible for a particular group of assets, with no rights given for groups of assets for which they have no responsibility. Since such access rights are unique to particular implementations and not a necessary part of, nor important to understanding, the structure or operation of systems according to the description herein, they will not be discussed further.

In general, where access limitation is part of an implementation, it is expected that entitlement to edit the rules will be limited to, for example, IT System Owner(s), IT Development Manager(s) and IT Support Manager(s).

As should be evident from the above, an advantage to the system and approach described herein is that the creation of rules and rule management is straightforward. In some implementations, rule templates can be provided that merely need to be filled in with the necessary information. In other implementations, rule creation can be more free form, with users being able to select from among a universe of pre-specified parameters, for example, a “location” parameter and apply certain values to that parameter, for example, “North America” or “Chicago” or an office identification number.

Once a rule has been formulated, either by populating pre-defined fields of a template, constructing it free-form, or using some other approach including, but not limited to, cloning as described herein, the rule is saved as a “draft” rule, meaning that the rule exists but is not effective. As a draft, the rule can be re-opened, reviewed by others, modified, deleted, etc. without concern that it will have any effect on deployed assets.

The next step in making a rule effective is “preview.” Preview invokes the rule preview service and rule validation service which checks to make sure that the rule can be deployed and allows one to see, in light of the other rules in effect, the effect that the draft rule will have if deployed.

Note that, even after a rule has been previewed, it remains a draft and is still not deployed. Thus, even if a previewed rule is valid, will not adversely affect anything else and will have the exact desired effect, the draft rule can still be modified or deleted.

Once a rule has been previewed and is valid, the rule can be deployed by “committing” the rule. A committed rule is actually applied to the system resources implicated by the rule.

Depending upon the particular implementation, all of the above can be made accessible via a command line interface approach, a graphical user interface approach or some other approach, although it is expected that most implementations will involve a graphical user interface, particularly if access is to be provided to remote locations via the internet. Since creation of graphical user interfaces are well known and conventional and any type of graphical interface can be used provided it is set up to operate consistent with the description herein, the details about the construction of any particular graphical user interfaces are omitted for brevity.

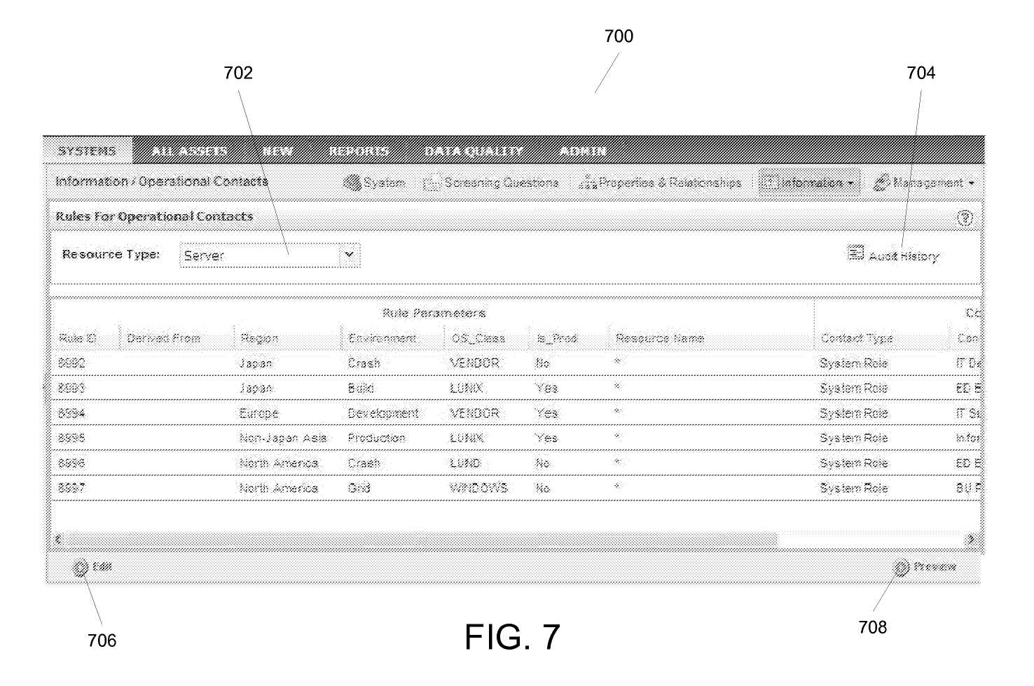

FIG. 7 is an illustrative example of a portion of a sample screen 700 of a graphical interface suitable for such an approach, which shows the committed rules for the systems. i.e. the rules that are currently applied on the system resources.

As shown and contemplated, the initial screen presented to virtually all authorized users is a non-editable, (i.e. “read only”) screen which shows committed rules, that is, the rules currently applied to system resources. As shown, the screen 700 of FIG. 7 contains a “Resource Type” pull-down menu box 702 which allows the user to filter the display to only show one or more particular resource types at a time.

The example screen 700 also contains an “Audit History Button” 704 which, if selected, allows the user to view the Audit History for the corresponding selected resource types.

An “Edit” button 706 or other selectable edit indicator is provided to enter the “Edit” mode if authorized. If a particular user is not authorized, the interface can be configured such that the “Edit” button 706 is not present or shown but disabled.

Similarly, a “Preview” button 708 can be provided to allow a user to Preview one or more of the rules.

Additional functionality can also be provided, for example an “Owners” button (not shown) can be provided in the interface to allow a user to view the owner(s) of one or more of the resources or the system to which the resource(s) belong(s).

In general, selecting one of the buttons on the interface either changes the displayed contents of the screen or, in some implementations, will bring up an entirely new screen or open a new window. For example, the interface can be configured such that clicking on “Audit History” causes a new window to open.

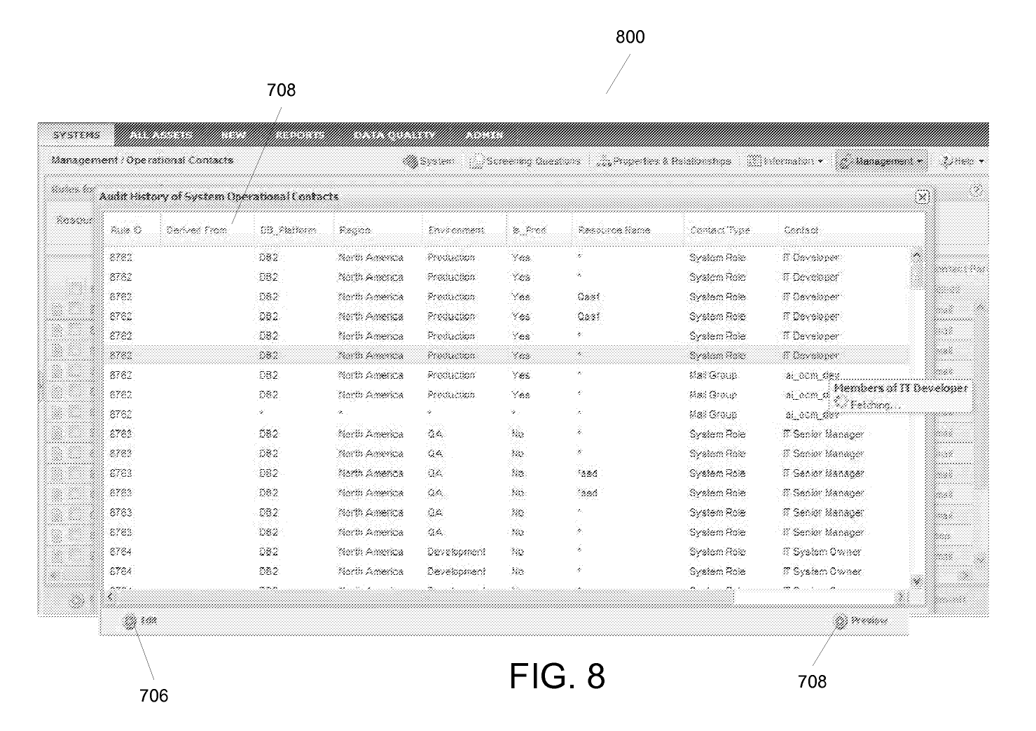

FIG. 8 is a representative, illustrative example of an Audit History window 800. As shown, the window contains the history of rules defined for corresponding resource type, which were newly inserted, deleted or updated as well as whether a rule was derived 802 from another rule. Depending upon the particular implementation, this display can be further limited by one or more of the fields, by time, or by com combination thereof. Optionally, or additionally, it can also show one or more of: the status (for example, “Draft” or “Committed”) of each rule, each rule's id, the user who performed any operations on a rule, each operation performed, the update day and time, and/or version of each of the rule(s). Alternatively, such additional information could be provided by highlighting, selecting or moving a cursor over a given entry for a rule which would cause, for example, that information to be displayed in a dedicated area of the view, triggering of a pop-up window containing the information over a portion of the display area, or cause the opening of an entirely new window or tab on the screen within which the information would be displayed.

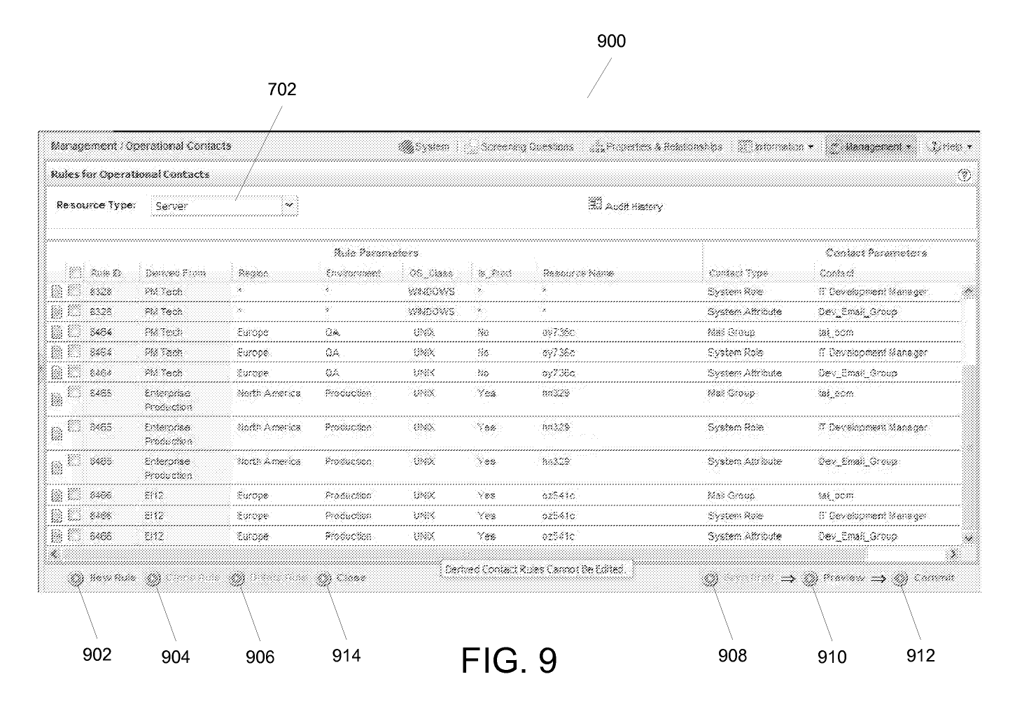

In similar fashion, if allowed for a particular user, selecting the “Edit” button 706 would invoke a screen applicable to the editable mode. FIG. 9 illustrates, in representative example form, an Edit interface screen 900 used for the editable mode. As shown, the “Edit” interface screen contains a listing of rules that are “Draft” (i.e. they have been added, updated or deleted but not yet committed). In general, the status of a rule will be identified in some fashion, for example, by color, a “Status” icon, a word, or other indicator. Once in the “Edit” mode, by making an appropriate selection of a rule and button rules can be created 902, cloned 904, deleted 906, saved 908, previewed 910 or committed 912.

Any suitable conventional method can be used to exit the “Edit” mode.

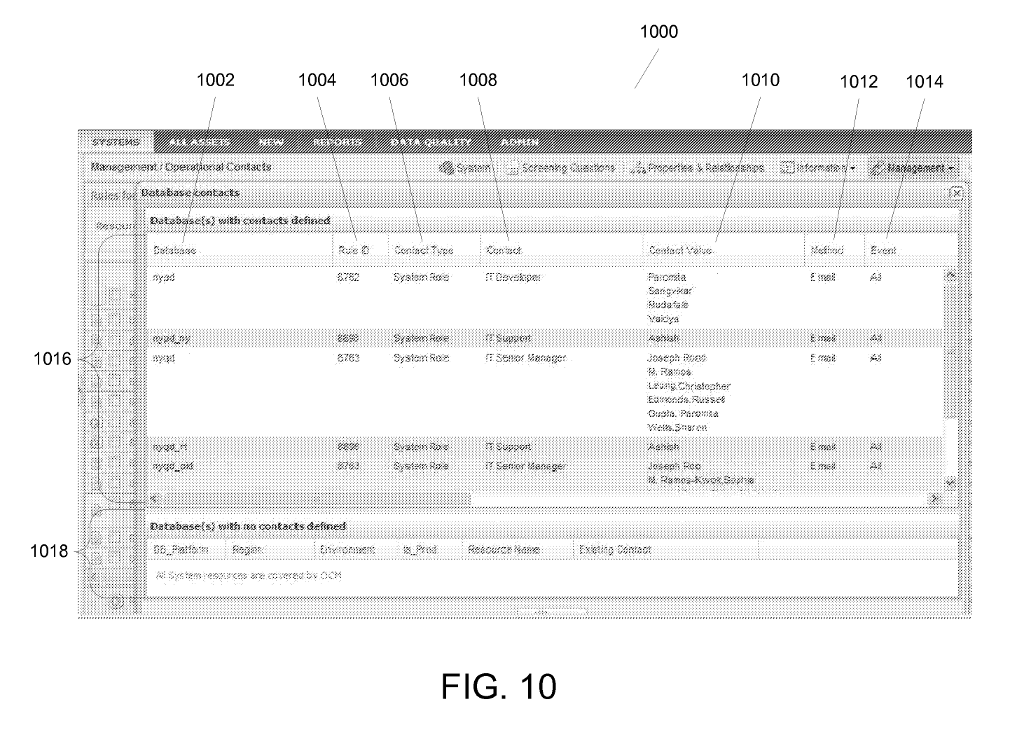

In a similar manner, a “Rules Preview” interface, for example a separate frame or window, is also provided. FIG. 10 illustrates an example “Rules Preview” interface screen 1000. The “Rules Preview” interface shows the effect of the rules being applied on the resources. Optionally, it can also display the contact(s) that will be in effect for each resource after each rule is applied. In this manner, a rule can easily be modified if an undesirable result or conflict will be caused if the rule were to be committed in “as is” form.

Depending upon the particular implementation, the system can be configured such that rules can be previewed from the non-editable mode as well. This can be useful, for example, to allow a user to see resources that are or are not covered under the contact rules.

As shown in FIG. 10, the interface 1000 contains columns of information for database resources including, an identification of the database 1002, the rule ID 1004, the type of contact 1006 for each database, further details about the contact 1008 (for example, the contact's title within the organization), the contact value 1010 (i.e. the name(s) or other identifying information, the method of contact to be used 1012, and the event(s) 1014 for which this contact should be contacted. In addition, it should be noted that the interface of FIG. 10 includes two panes 1016, 1018, one 1016 for databases with contacts and one 1018 for databases with no contacts. Advantageously, this approach ensures that all resources are displayed, whether or not they have contact information, so that resources that have no contact information can be assigned such information. Similarly, in some implementations, this approach can be used to identify resources where contact information has become invalid. For example, if the contact information for a particular resource has been a mail group “DB-Support-NA”, but changes in the organization cause that mail group to be eliminated and its members split up among three different groups, for example, “IT-Support-US-East,” “IT-Support-US-West” and “IT-Support-CA_MX”, elimination of the “DB-Support-NA” would cause that contact to become invalid and could cause that resource to appear in the “no contacts” pane or window 1018, thereby indicating that the contact information of the applicable rule must be updated.

In use, as indicated above, rules can be created anew, deleted, modified (to add information without deleting existing information, for example, an additional contact) and updated (to delete some existing information). Note that separating the addition of new information and the ability to modify existing information adds a level of security to the system, because a user can be allowed to add information without fear that they will inadvertently, undesirably change other information. Alternatively, the modification and updating can be handled as one. Advantageously, with the instant approach, each can be done in only a few steps outlined below with reference to FIGS. 7 and 9:

Example steps to Create a new rule:

1. Select Resource Type 702.

2. Click on Edit Button 706.

3. Click on New Rule 902.

4. Enter Rule parameters and Contact parameters (to be a valid rule, in general, values must be present in all fields.

5. Click “Save Draft” 904. Note that, to partially enforce rule validity, the interface can be configured such that the “Save Draft” button 904 is only enabled after all fields have values. Selecting “Save Draft” saves this as draft rule.

Note that, the rule will not be applied to the resources unless it is committed, i.e. the settings will only come into effect after committing the rule.

Example steps to delete a rule:

1. Select Resource Type 702.

2. Click the Edit button 706.

3. Select the rule to delete. The “Delete Rule” button 906 would only be enabled after selection of a Rule.

4. Click on “Delete Rule” 906. Note that, as contemplated, at this point, the status of the rule will be changed to something indicating that the rule was marked for deletion, but would only be deleted when committed.” A rule marked for deletion cannot be edited further. In addition, selecting “Delete Rule” 906 saves the changes as draft rule. The rule deletion is not applied to the resources unless it is committed.

Example steps to add new information to an existing rule:

1. Go to Edit Mode.

2. Select the rule to be added to.

3. Click on “Clone Rule” button 904 and a new rule will appear with the same values as the selected (i.e. parent) rule.

4. Add the additional information.

5. Click on “Save Draft” 908 to save as a draft rule. Again, the rule will not be applied to the resources unless it is committed.

Note that if modifying and updating are combined, then the steps would be the same except any value in the rule could be changed.

If modifying and updating are separate, the steps to update a rule could be:

1. Go to Edit Mode.

2. Change the value(s) in the rule.

3. Click on “Save Draft” 908. At this point, the rule will be modified. but the last committed version would still be in effect. Thus, the status would be changed by the “Save Draft” process to now show that this rule has been “Updated” but not yet committed.” Again, the updated rule will not be applied to the resources unless it is committed.

Once a rule has been modified in some fashion, the user can use the “Preview” mode (FIG. 10) to preview the effect of the draft rule if it were to be applied on the system resources. In other words, the effect of the “former” rule would be ignored and the effect of the modified rule shown in its place. Based on the resource coverage and/or other factors the user can then decide to “Commit” 912 the rule “as is,” to further update the draft rule in some manner or, if need be, delete it.

Optionally, a “Clone Rule” option can be provided, for example to save time when it is expected that multiple rules may be created but most of the contents of two or more rules will be substantially the same. Note here that, as contemplated, the system would be set up so that no two rules can be identical. Where the optional “Clone Rule” aspect is provided, when selected, it would create a new draft rule that starts out identical to an existing rule but must be edited in order to be saved as a draft rule. Where this option is provided, the steps could involve:

1. Selecting the rule to clone.

2. Clicking the “Clone Rule” button 904 (resulting in a new rule appearing with the same values as the parent rule).

4. Making some change(s) to the new rule and

5. Clicking on “Save Draft” 908 to save this rule as draft rule. As with the above, the rule would not be applied to the resources unless it is committed.

As a further option, a “Cancel” button can be provided to cancel unsaved changes. Similarly, a “Close” button 914 can be provided to return to the Non Editable mode. Depending upon the particular implementation, for safety, if a user clicks the “Close” button 914 when a rule is open but “Save Draft” 908 has not yet been selected the system can be configured to issue an appropriate warning and discard all actions subsequent to the last “Save Draft”, “Commit” or entry into the “Edit” mode as appropriate, or it can do so without the warning. In this manner, the requirement that a draft rule be complete can be indirectly enforced.

In general, the selection of “Save Draft” 908 results in a background validation process. For example, the validation process could ensure that:

1. all fields have allowable values,

2. if the contact type required a mail group (as opposed to an individual), the contents is a valid group,

3. if the contact type required a mail group, it could not only check the group validity, but also check to ensure that the identified mail group contains at least one valid member,

4. if the contact type is a System Role, the role must have at least one valid person assigned to that role, and/or

5. the rule cannot now be identical to another rule, whether because it is an unchanged “Clone” rule or a rule that has been modified such that it now is identical to an existing rule.

Only if the appropriate validation process is satisfied will a rule actually be saved as a draft rule.

In some implementations, it may be desirable to for changes to not be immediately updated after the user commits a rule, for example, for specific systems that receive heavy usage, are time critical or for provisioning system. In such cases, a batch process or queue approach can be used with jobs set up to run periodically to update the downstream system information based on the rule changes at an appropriate time or upon a particular event, for example, at midnight or upon usage dropping below some specified percentage for more than a certain amount of time (as an indicator of low demand for the period needed to run the job and perform the update).

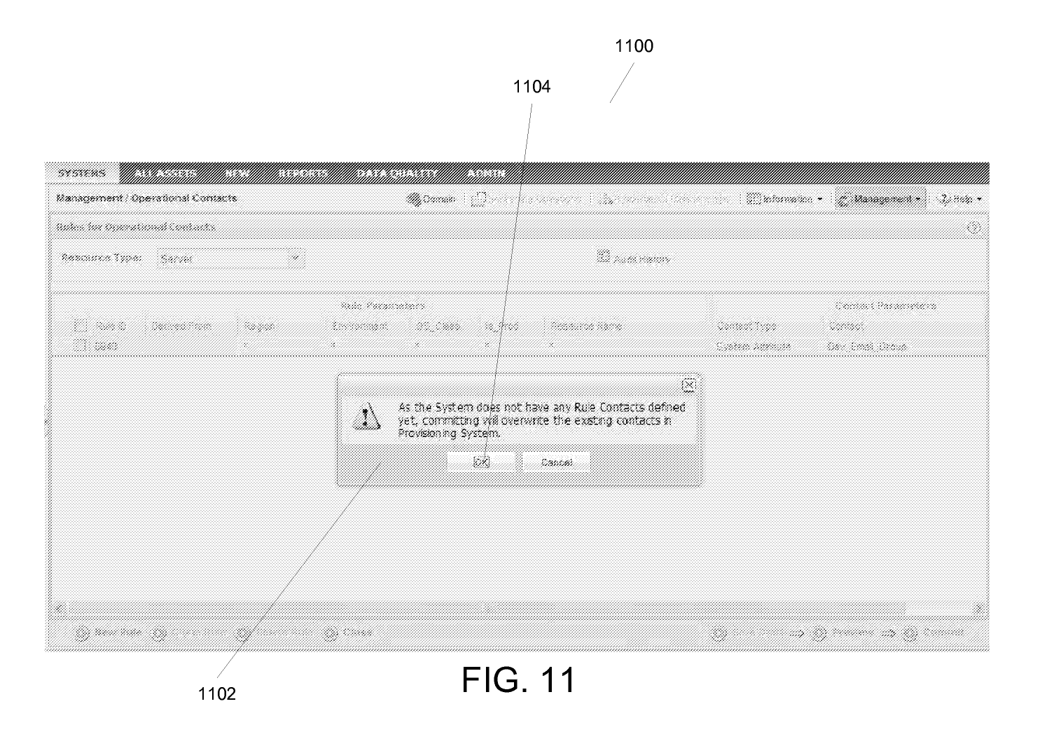

Once a draft rule is ready to be implemented (i.e. actually take effect in the system) the user selects the draft rule(s) to take effect and selects “Commit” 912. If there are no rules to commit and the “Commit” button 912 is selected, nothing will change with respect to the rules and, optionally, an alert 1102 (for example, as shown in FIG. 11) can be given on the screen 1100 indicating that there are no rules to commit for the system. Alternatively, although less desirably, if no rule is selected and a “Commit” is initiated, all the pending draft rules can be committed. In any event, “Commit” will change the draft rule's status from Draft to Commit and it will either take effect immediately, overwriting any existing prior rule in effect for such resource(s) or, with a batch or queued approach, upon running of the batch job or implementing the rule containing job in the queue. In some cases, for example, if the user is committing a rule for the first time for a given resource (i.e. its current contact information is only in the provisioning system, an alert or warning can be given (FIG. 11) that the System does not have any rule contacts defined yet for that resource and that committing will therefore overwrite the existing contacts in the provisioning system. Where a warning or alert is given, the user can be provided with an option to cancel the action or confirm that the action should, nevertheless, take place, for example by clicking on an “OK” button 1104.

Advantageously, the above approach makes it easy to modify any component of a rule as needed and, moreover, the nature of the graphical interface design can be used to augment this approach.

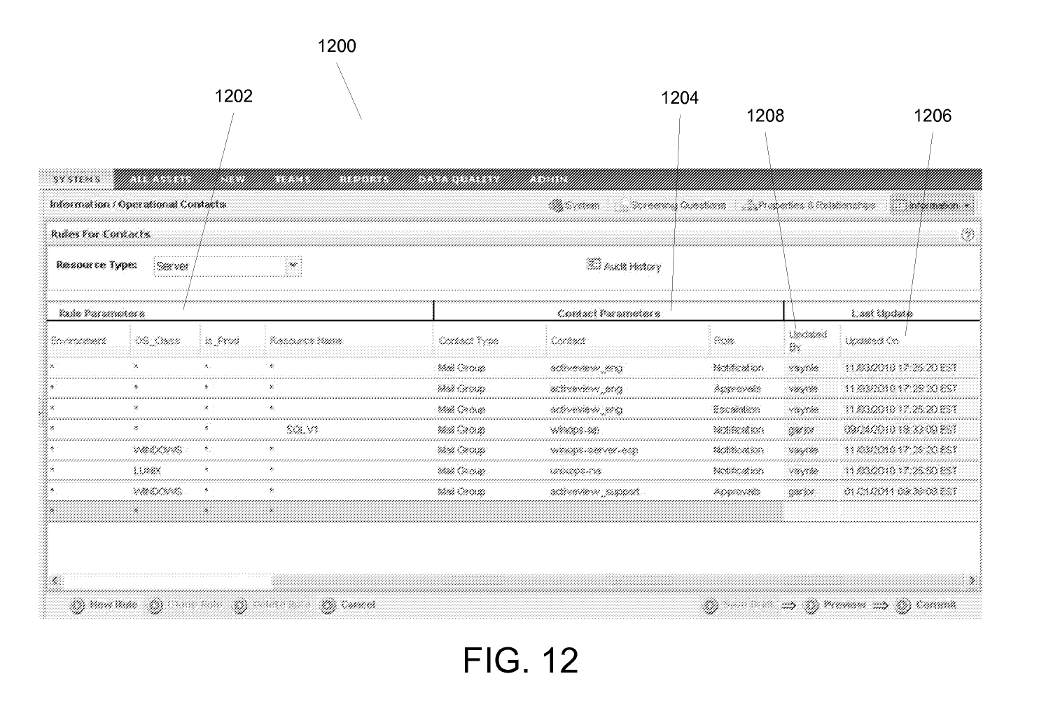

FIG. 12, illustrates an alternative example edit interface screen 1200 as described above with information resource type=“Servers” selected in the “Resource Type” pull down menu. As can be seen, the screen contains various Rule Parameters 1202 and Contact Parameters 1204 as well as an indication of when each rule was last updated 1206 and by whom 1208.

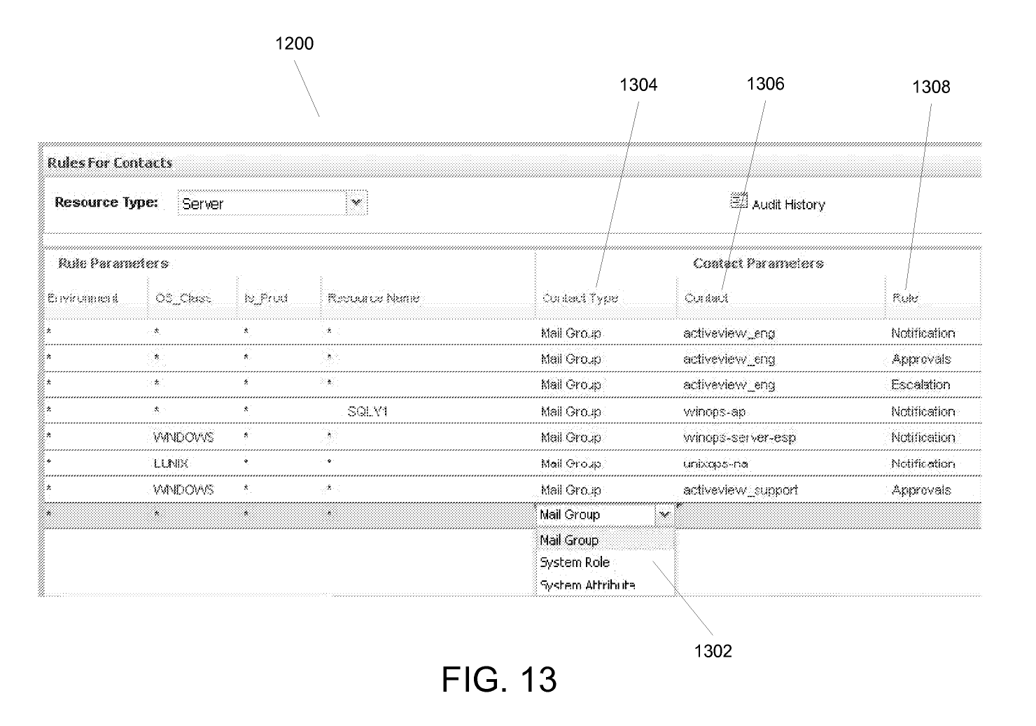

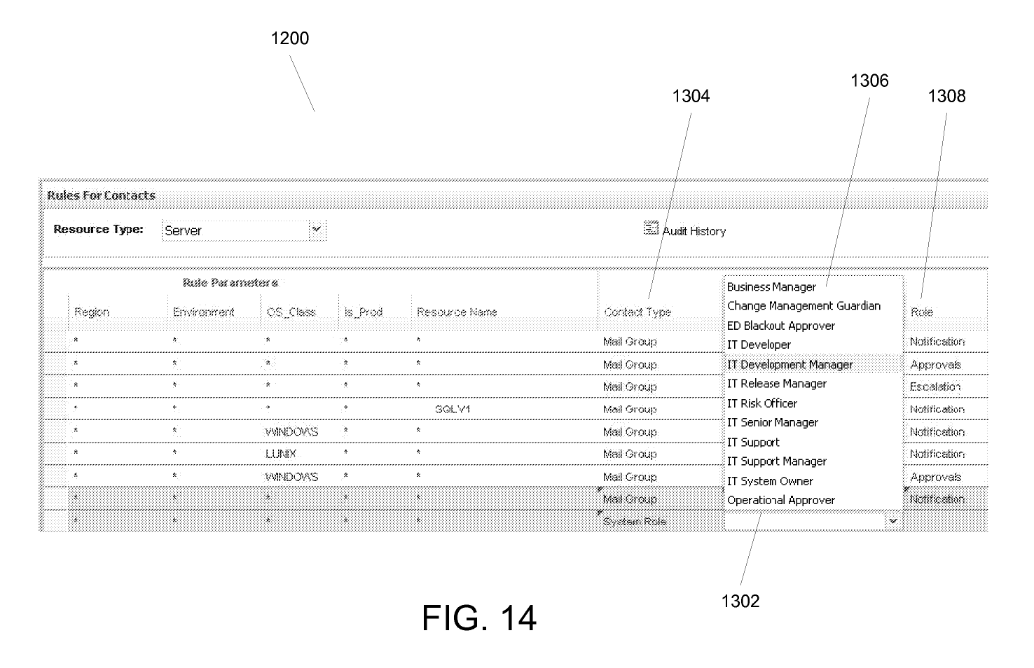

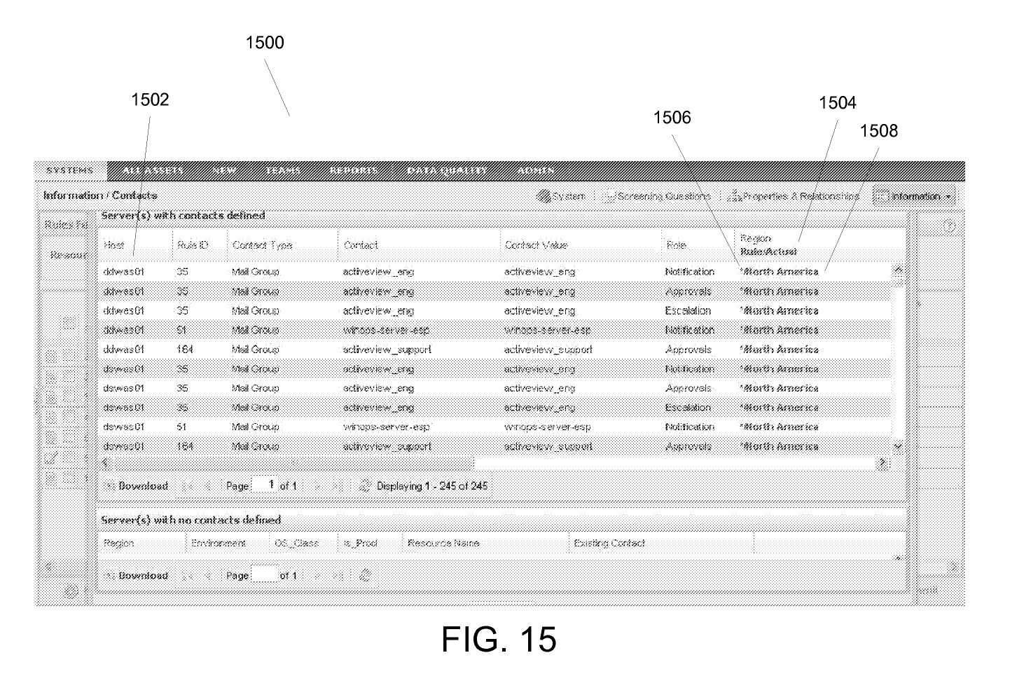

FIGS. 13 and 14 are an enlarged portion of the screen 1200 of FIG. 12. As can be seen in these views, the interface can advantageously be configured such that, when a rule is created or edited, the content of certain fields of the Rule Parameters and/or Contact Parameters can be limited to a predefined, set of allowable inputs. This can be accomplished, for example, by using a pull down menu 1302, with, for example, selectable entries for the “Contact Type,” 1304 (FIG. 13) “Contact” 1306 (FIG. 14) and/or “Role” 1308 fields.

FIG. 15 is an enlarged portion of a screen 1500, similar to the screen 1000 of FIG. 10, except that it is for servers instead of databases. In this screen 1500 each server asset is identified 1502 along with the rule, contact and role information as described above. Moreover, in this view, the column 1504 identifying the rule status 1506, in this case indicated as an active rule by an asterisk, and the region 1508 to which the rule and contact information pertains.

Thus, it should be appreciated that the use of a graphical interface provides advantages over and above the arrangement itself. However, as noted above, although a graphical interface has been described above and, by its very nature provides various inherent benefits, a graphical interface is not required. Instead, a command line type interface could be used to accomplish the same tasks, although much of the flexibility would be lost by doing so.

It should be understood that this description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. An apparatus comprising:
multiple servers, at least one of the multiple servers being geographically remote from at least another of the multiple servers;
an asset inventory comprising multiple distributed applications;
each of the multiple servers being owned by at least one of the multiple distributed applications;
each of the multiple servers having associated server contact information and application contact information, the contact information identifying whom to contact when an alert event occurs;
at least one network interconnecting some of the multiple servers to others of the multiple servers; and
a central connection manager comprising a contact rules engine, the contact rules engine being configured to allow contact rule creation and to provide contact rule management such that created contact rules will apply to each of the multiple distributed applications and servers owned by each of the multiple distributed applications and when a change is made to a contact rule that affects one or more of server contact information and application contact information for one of the multiple distributed applications the change will be implemented throughout the at least one network for the one of the multiple distributed applications and all servers owned by the one of the multiple distributed applications.

2. The apparatus of claim 1, wherein at least one of the distributed applications comprise at least one distributed database application.

3. The apparatus of claim 1, wherein at least one of the server contact information or application contact information includes at least one field containing contact attributes.

4. The apparatus of claim 1, wherein at least one of the server contact information or application contact information includes a contact type.

5. The apparatus of claim 4, wherein the contact type includes one of: a mail group or a system role.

6. The apparatus of claim 5, wherein the contact type is a system role and wherein the system role comprises one of: notification, escalation, or approval.

7. The apparatus of claim 1 wherein the contact rules engine is configured to prohibits two created rules from having identical content.

8. The apparatus of claim 1 wherein the contact rules engine is configured to prohibit the server contact information or application contact information from being specific contact information for an individual person.

9. The apparatus of claim 1 wherein the contact rules engine is configured to validate each new rule.

10. The apparatus of claim 9 wherein each of the multiple distributed applications and each of the multiple servers has associated with it at least one validated contact rule.

11. The apparatus of claim 1 wherein each of the multiple distributed applications and each of the multiple servers has associated with it at least one contact rule.

12. The apparatus of claim 1, wherein at least one of the multiple servers includes a legacy contact repository for at least and wherein the connection manager takes specific contact information that is applicable to the at least one of the multiple servers in a rule and propogates the specific contact information from the rule to the legacy contact repository.

13. A computerized method of managing contact information for deployed applications and deployed servers in a geographically distributed network comprising:
maintaining an ownership relationship between the deployed applications and the deployed servers such that every server is owned by at least one application;
maintaining, within a connection management computer system, a centralized repository of contact rules specifying for each of the deployed applications and deployed servers, each of the contact rules comprising rule parameters and contact parameters applicable to at least one the deployed applications or the deployed servers; and
managing the contact rules such that
a) when a rule parameter of a specific rule changes, the change will be applied to all impacted deployed applications and all applicable deployed servers owned by the impacted deployed applications to which the specific rule applies, and
b) when a new rule is added and validated, its parameters will become effective for every application and server to which the rule applies.

14. The method of claim 13, where, when the new rule is added, the method further comprises:
validating the new rule and, only if the new rule is a valid rule, making its parameters effective.

15. The method of claim 13 further comprising:
adding at least one of operating system identifying information or resource identifying information into a rule parameter of an individual rule.

16. The method of claim 15 further comprising:
adding at least one of a contact type, a contact or a role into a contact parameter of the individual rule.

17. The method of claim 13 further comprising:
adding at least one of a contact type, a contact or a role into a contact parameter of an individual rule.

18. The method of claim 13 further comprising:
providing a graphical user interface to facilitate at least one of rule creation or rule modification.

19. The method of claim 18 further comprising:
limiting contents of a rule field to information contained in a predefined list of information.

20. The method of claim 18 further comprising:
providing, within the graphical user interface, discrete screens for rule editing and rule preview.
